(19) United States
(12) Patent Application Publication
(10) Pub. No.: US 2026/0329748 A1
(43) Pub. Date: Oct. 22, 2026

(54) METHOD AND STORAGE DEVICE FOR MANAGING READ DISTURBANCE IN STORAGE DEVICE WITH INTENSIVE READ WORKLOAD

(71) Applicant: SAMSUNG ELECTRONICS CO., LTD., Suwon-si (KR)

(72) Inventors: Nishchay MALAKAR, Bengaluru (IN); Anantha Sharma, Bengaluru (IN); Gangheyamoorthy Ayyanar Ponnusamy, Bengaluru (IN); Kiranmayi Kamalay, Bengaluru (IN); Pankaj Kumar Gautam, Bengaluru (IN); Praveen C Bademi, Bengaluru (IN); Sharath Kumar Kodase, Bengaluru (IN); Talluri Sai Dilip, Bengaluru (IN)

(73) Assignee: SAMSUNG ELECTRONICS CO., LTD., Suwon-si (KR)

(21) Appl. No.: 19/232,310

(22) Filed: Jun. 9, 2025

(30) Foreign Application Priority Data
Apr. 21, 2025 (IN) 202541037942

(51) Int. Cl. G06F 12/02

(52) U.S. Cl. CPC G06F 12/0246; G06F 2212/7205

(57) ABSTRACT

A method may include: reading a first Logical Block Addresses (LBA) from a host read buffer; identifying a first read disturbance in the first LBA; copying first data associated with the first LBA to a Garbage Collector (GC) buffer pool, based on the identifying the first read disturbance; reading a second LBA from the host read buffer; identifying a second read disturbance in the second LBA; copying second data associated with the second LBA to the GC buffer pool, based on the identifying the second read disturbance; generating a reclaim queue including the first LBA and the second LBA; identifying at least part of the first data and the second data to be written from the GC buffer pool to a GC destination block; and writing the at least part of the first data and the second data to the GC destination block.

### CROSS-REFERENCE TO RELATED APPLICATION

This application is based on and claims priority to Indian Patent Application No. 202541037942, filed on Apr. 21, 2025, in the Indian Patent Office, the disclosure of which is incorporated by reference herein in its entirety.

### BACKGROUND

The present disclosure relates to storage devices. More particularly, the present disclosure relates to managing read disturbance in the storage device with intensive read workload.

Generally, a storage device such as Solid State Devices (SSDs) have intensive read workload. A read command is received from a host device to retrieve data stored in the SSD. The data stored in the SSD is assigned corresponding Logical Block Addresses (LBAs). Further, each of these LBAs have a corresponding maximum number of read commands that may be executed. Each of these LBAs have one or more pages associated with them. The pages comprise the data that is retrieved on receiving a read command. Some pages in an LBA may be read more than others based on the received read command.

When a large number of read operations are performed on one or more pages within the same LBA, a read disturbance occurs for that LBA. Data in that LBA should be written to a different destination block to avoid the data being lost. Further, the LBA has a read command time-out i.e., the data associated with the LBA should be moved before a predefined time-period. During intensive read workloads, one or more of the LBAs may have the read disturbance simultaneously. However, SSDs may write the data of the LBAs sequentially, i.e., only when data associated with one LBA is written to the destination block, data associated with next LBA is written to the destination block. In some cases, the data associated with an LBA may not get written to the destination block before the read command time-out. In this case, the LBA may enter an unreadable state, and the data associated with the LBA may be lost.

The information disclosed in this background of the disclosure section is only for enhancement of understanding of the general background of the invention and should not be taken as an acknowledgement or any form of suggestion that this information forms the related art already known to a person skilled in the art.

### SUMMARY

The foregoing summary is illustrative only and is not intended to be in any way limiting. In addition to the illustrative aspects, embodiments, and features described above, further aspects, embodiments, and features will become apparent by reference to the drawings and the following detailed description.

According to an example embodiment, a method of managing read disturbance in a storage device, may include: reading a first Logical Block Addresses (LBA) from a host read buffer; identifying a first read disturbance in the first LBA; copying first data associated with the first LBA to a Garbage Collector (GC) buffer pool, based on the identifying the first read disturbance; reading a second LBA from the host read buffer; identifying a second read disturbance in the second LBA; copying second data associated with the second LBA to the GC buffer pool, based on the identifying the second read disturbance; generating a reclaim queue including the first LBA and the second LBA; identifying at least part of the first data and the second data to be written from the GC buffer pool to a GC destination block; and writing the at least part of the first data and the second data to the GC destination block, based on the reclaim queue, to avoid the at least part of the first data and the second data being lost.

According to an example embodiment, a storage device for managing read disturbance in the storage device, may include: at least one processor; and memory configured to store instructions that, when executed by the at least one processor, cause the at least one processor to: read a first Logical Block Addresses (LBA) from a host read buffer; identify a first read disturbance in the first LBA; copy first data associated with the first LBA to a Garbage Collector (GC) buffer pool, based on identifying the first read disturbance; read a second LBA from the host read buffer; identify a second read disturbance in the second LBA; copy second data associated with the second LBA to the GC buffer pool, based on the identifying the second read disturbance; generate a reclaim queue including the first LBA and the second LBA; identify at least part of the first data and the second data to be written from the GC buffer pool to a GC destination block; and write the at least part of the first data and the second data to the GC destination block, based on the reclaim queue, to avoid the at least part of the first data and the second data being lost.

According to an example embodiment, a non-transitory computer-readable storage medium, having a program stored thereon that may perform, when executed by at least one processor: reading a first Logical Block Addresses (LBA) from a host read buffer; identifying a first read disturbance in the first LBA; copying first data associated with the first LBA to a Garbage Collector (GC) buffer pool, based on the identifying the first read disturbance; reading a second LBA from the host read buffer; identifying a second read disturbance in the second LBA; copying second data associated with the second LBA to the GC buffer pool, based on the identifying the second read disturbance; generating a reclaim queue including the first LBA and the second LBA; identifying at least part of the first data and the second data to be written from the GC buffer pool to a GC destination block; and writing the at least part of the first data and the second data to the GC destination block, based on the reclaim queue, to avoid the at least part of the first data and the second data being lost.

### BRIEF DESCRIPTION OF THE DRAWINGS

Embodiments will be more clearly understood from the following detailed description taken in conjunction with the accompanying drawings in which:

FIG. 1 illustrates an exemplary environment 100 in which one or more embodiments of the present disclosure may be implemented;

FIG. 2 illustrates a block diagram 200 of a storage device for managing read disturbance in the storage device with intensive read workload, in accordance with one or more embodiments of the present disclosure;

FIG. 3 illustrates a block diagram 300 depicting operation of various modules of a storage device for managing read disturbance in a storage device with intensive read workload, in accordance with one or more embodiments of the present disclosure;

FIG. 4 illustrates a block diagram 400 depicting a plurality of Logical Block Addresses (LBAs), in accordance with one or more embodiments of the present disclosure;

FIG. 5 illustrates a flow chart of a method 500 of managing read disturbance in a storage device with intensive read workload, in accordance with one or more embodiments of the present disclosure; and

FIG. 6 illustrates a block diagram of an exemplary computer system 600 for implementing embodiments consistent with the present disclosure.

It should be appreciated by those skilled in the art that any block diagram herein represents conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternatives falling within the scope of the disclosure.

The terms “comprises”, “comprising”, or any other variations thereof, are intended to cover a non-exclusive inclusion, such that a setup, device or method that comprises a list of components or operations does not include only those components or operations but may include other components or operations not expressly listed or inherent to such setup or device or method. In other words, one or more elements in a system or apparatus proceeded by “comprises . . . a” does not, without more constraints, preclude the existence of other elements or additional elements in the system or apparatus.

While the disclosure is susceptible to various modifications and alternative forms, specific embodiments thereof have been shown by way of example in the drawings and will be described in detail below. It should be understood, however, that it is not intended to limit the disclosure to the particular forms disclosed, but on the contrary, the disclosure is to cover all modifications, equivalents, and alternatives falling within the scope of the disclosure.

The terms like “SSD”, “SSD device” and “storage device” have been used interchangeably throughout the disclosure. Further, the terms like “host” and “host device” and “host computer” have been used interchangeably throughout the disclosure. The terms like “host controller”, “processor”, “processing unit” and “central processing unit” have been used interchangeably throughout the disclosure.

A storage system may comprise a host device communicatively coupled with a storage device. The storage device may comprise a non-volatile memory and/or a Dynamic Random Access Memory (DRAM). The non-volatile memory may be a flash memory that does not lose the stored data even when power supplied to the memory is cut off.

The host device enables the operating system and applications to access stored data from a storage device without needing to know a physical layout of the storage device. The flash memory may be logically divided into blocks, with each of the blocks further divided into logically addressable pages. Logical Block Addressing (LBA) technique is used for converting logical block addresses to actual physical addresses on the storage device. By managing data at the block level and assigning LBAs to individual data blocks, SSDs can optimize data storage and retrieval processes and improve performance and reliability. Each of these LBA includes one or more logically addressable pages.

The present disclosure provides methods and a storage device for managing read disturbance in the storage device with intensive read workload. In the present disclosure, at least one LBA with a read disturbance is identified from a plurality of LBAs. The at least one LBA is copied to a Garbage Collector (GC) buffer pool before a read command time-out. Further, the at least one LBA is written to a GC destination block. Thereby, ensuring that an LBA with a read disturbance is written to the destination block before the read command time-out, further ensuring that the LBA does not go into unreadable state. Therefore, the present disclosure avoids data associated with the at least one LBA being lost.

The embodiments of the present disclosure is explained with respect to the plurality of LBAs from a NAND block, however it is not limited thereto.

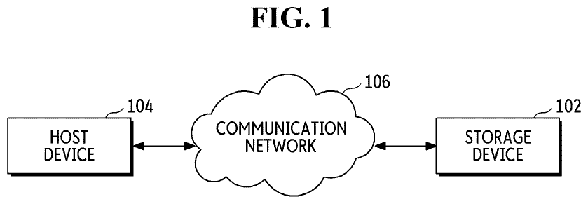

FIG. 1 illustrates an exemplary environment 100 in which one or more embodiments of the present disclosure may be implemented.

The exemplary environment 100 corresponds to a storage system comprising a storage device 102 configured to communicate with a host device 104 via a communication network 106. In one or more embodiments, the host device 104 may be communicatively coupled with the storage device 102. In an exemplary aspect, the storage device 102 may be a Solid State Drive (SSD). In one or more embodiments, the host device 104 may be, but not limited to, any mobile or non-mobile device such as, but not limited to, a portable communication terminal (e.g., a mobile phone), a smartphone, a tablet personal computer (PC), a wearable device, a healthcare device, an Internet of things (IOT) device, a Personal Computer (PC), a laptop computer, a server, a media player, or an automotive device (e.g., a navigation device).

In one or more embodiments, the host device 104 communicates with the storage device 102 via the communication network 106. For example, when an application needs to read data from the storage device 102, the host device 104 invokes system calls to perform file read operations through the communication network 106. In one or more embodiments, the host device 104 may execute a video application, a game application, a Web browser application, and the like to provide various services. The host device 104 is coupled with the storage device 102 to access the above mentioned applications stored in the storage device 102. In one or more embodiments, the host device 104 may communicate with the storage device 102 to write data to the storage device 102. For example, if the host device 104 downloads a new application and wants to access this application in future, the host device 104 may send the application to the storage device 102 to perform write operation. In one or more embodiments, once an application is written to the storage device 102 i.e., when the application is stored on the storage device 102, the storage device 102 may perform read operations. The data stored in the storage device 102 is assigned corresponding Logical Block Addresses (LBAs). A fixed number of read operations may be performed for each of the LBAs in the storage device 102. In one or more embodiments, a read disturbance phenomenon is said to occur when a large amount of read operations are performed on one or more pages within the same LBA.

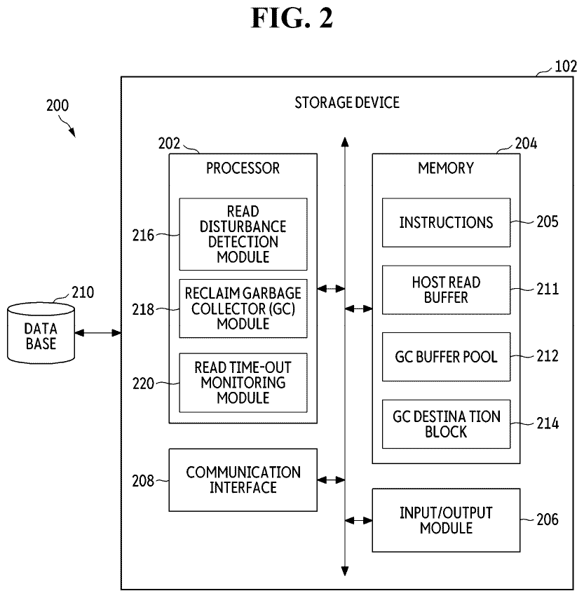

In one or more embodiments, considering that the storage device 102 comprises a plurality of LBAs. In related art storage devices, when a read disturbance occurs in an LBA from the plurality of LBAs, data associated with that LBA is copied and stored at a different location (for example, a destination block). However, in real time, the read disturbance may occur in more than one LBA. In the related art storage devices, when a read disturbance occurs in more than one LBAs, the LBA in which the first read disturbance occurs is copied to the destination location then, the next LBA is copied to the destination block. However, moving the LBAs with read disturbance one by one is time consuming. Further, in some cases, the LBAs with the read disturbance may go into an unreadable state with a predefined read command timeout. Therefore, it is important to copy and write the data into the destination block before the read command timeout. As indicated earlier, each of the plurality of LBAs has a corresponding fixed number of read operations. In one or more embodiments, consider an LBA ‘A’ has 10,00,000 read operations. The read disturbance is observed in the LBA ‘A’ while performing 99,999^{th} read operation. In this embodiment, the LBA ‘A’ should be written to the destination block is the next read operations. However, in related art storage systems, as each LBA with the read disturbance is written to the destination block one by one, in some cases, when read operation of the LBA ‘A’ is initiated, the storage devices may perform the read operation on the LBA ‘A’. In this example, the LBA ‘A’ is now in an unreadable state and cannot be copied to destination block. Therefore, data associated with the LBA ‘A’ is permanently lost. To overcome the above mentioned problems, the storage device 102 is deployed. The operations performed by the storage device 102 are explained in detail in upcoming paragraphs with reference to FIG. 2.

FIG. 2 illustrates a block diagram 200 of the storage device 102 for managing read disturbance in a storage device with intensive read workload, in accordance with one or more embodiments of the present disclosure. The storage device 102 may establish a connection with the host device 104 to receive the read operations.

As depicted in FIG. 2, the storage device 102 includes (at least one) processor 202, memory 204, Input/Output (I/O) module 206, and communication interface 208. It may be noted that, in one or more embodiments, the storage device 102 may include more or fewer components than those depicted herein. The various components of the storage device 102 may be implemented using hardware, software, firmware, or any combinations thereof. Further, the various components of the storage device 102 may be operably coupled with each other. More specifically, various components of the storage device 102 may be capable of communicating with each other using communication channel media (such as buses, interconnects, etc.). The processor 202 may comprise at least one data processor for executing program components for executing user or system-generated requests. The memory 204 may be communicatively coupled to the processor 202. The memory 204 stores instructions, executable by the processor 202, which, on execution, may cause the processor 202 for managing read disturbance in the storage device 102 with intensive read workload.

In one or more embodiments, the processor 202 may be embodied as a multi-core processor, a single core processor, or a combination of one or more multi-core processors and one or more single core processors. For example, the processor 202 may be embodied as one or more of various processing devices, such as a coprocessor, a microprocessor, a controller, a digital signal processor (DSP), a processing circuitry with or without an accompanying DSP, or various other processing devices including, a microcontroller unit (MCU), a hardware accelerator, a special-purpose computer chip, or the like. The processor 202 may include, but not limited to, a read disturbance detection module 216, a reclaim Garbage Collector (GC) module 218 and a read command timeout module 220.

In one or more embodiments, the I/O module 206 may include mechanisms configured to receive inputs from and provide outputs to an operator of the host device 104. To enable reception of inputs and provide outputs from the storage device 102, the I/O module 206 may include at least one input interface and/or at least one output interface. Some examples of the input interface may include, but are not limited to, a keyboard, a mouse, a joystick, a keypad, a touch screen, soft keys, a microphone, and the like. Examples of the output interface may include, but are not limited to, a display such as a light emitting diode display, a thin-film transistor (TFT) display, a liquid crystal display, an active-matrix organic light-emitting diode (AMOLED) display, a microphone, a speaker, a ringer, and the like.

In one or more embodiments, the communication interface 208 may include mechanisms configured to communicate with other entities in the environment 100, for example, the host device 104. In one or more embodiments, the storage device 102 may initiate establishing a connection with the host device 104 via the communication interface 208. The processor 202 is configured to read a plurality of LBAs from a host read buffer 211 in the memory 204.

In one or more embodiments, the host read buffer 211 may include the plurality of LBAs, and the host read buffer 211 may be stored in a database 210. The storage device 102 is depicted to be in operative communication with the database 210. In one embodiment, the database 210 is configured to store host read buffer 211, GC buffer pool 212 and GC destination block 214.

The database 210 may include multiple storage units such as hard disks and/or solid-state disks in a redundant array of inexpensive disks (RAID) configuration. In one or more embodiments, the database 210 may include a storage area network (SAN) and/or a network attached storage (NAS) system. In one embodiment, the database 210 may correspond to a distributed storage system, wherein individual databases are configured to store custom information, such as a plurality of LBAs, and the like.

In one or more embodiments, the database 210 is integrated within the storage device 102. For example, the storage device 102 may include one or more hard disk drives like database 210. In other embodiments, the database 210 is external to the storage device 102 and may be accessed by the storage device 102 using a storage interface. The storage interface is any component capable of providing the processor 202 with access to the database 210. The storage interface may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 202 with access to the database 210.

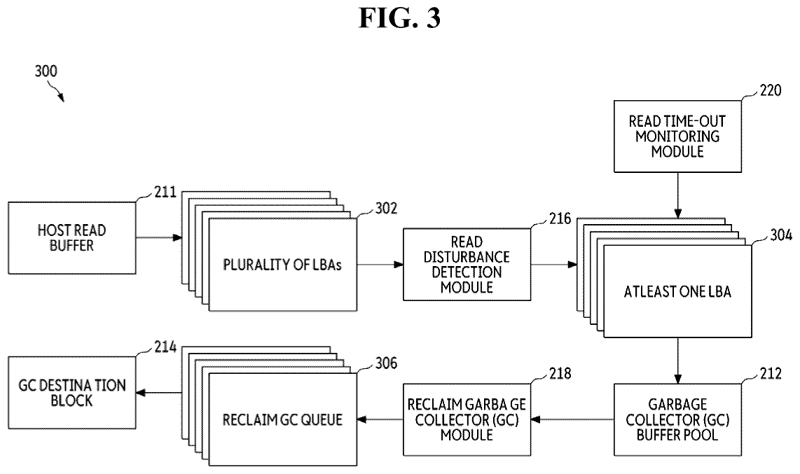

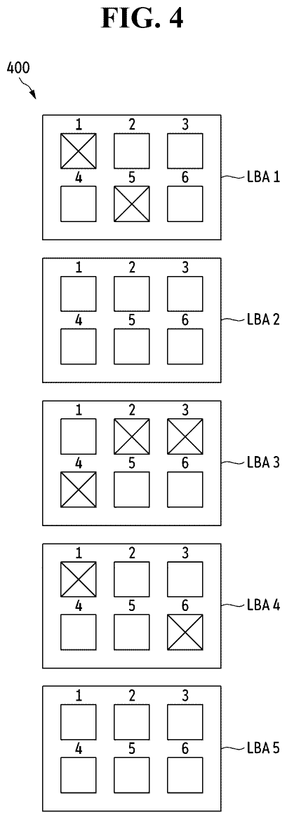

The functionalities of the one or more components of the processor 202 is provided below in detail in conjunction with FIG. 3 and FIG. 4.

In one or more embodiments, FIG. 3 illustrates a block diagram 300 depicting operation of various modules of a storage device 102 for managing read disturbance in the storage device 102 with intensive read workload. The read disturbance detection module 216, reads a plurality of LBAs 302 from the host read buffer 211. The read disturbance detection module 216 identifies a read disturbance in at least one LBA 304 from the plurality of LBAs 302. The plurality of LBAs 302 are illustrated in FIG. 4. In particular, the plurality of LBAs 302 as depicted in FIG. 4 are represented as LBA 1 (e.g. first LBA), LBA 2, LBA 3 (e.g. the second LBA) . . . LBA 5. Each of the plurality of LBAs, i.e., LBA 1, . . . , LBA 5 comprises a plurality of address pages depicted as 1, 2, 3, 4, 5 and 6. The LBA 1 depicted in FIG. 4 comprises pages 1, 2, 3, . . . 6. In this example, the pages 1 and 5 have been identified to have a read disturbance. Similarly, pages 2, 3 and 4 have the read disturbance in LBA 3 and pages 1 and 6 from LBA 4. However, LBAs 2 and 5 have no read disturbance. In this example, now referring back to FIG. 3 the read disturbance detection module 216 identifies the LBAs 1, 3 and 4 to have the read disturbance. In one or more embodiments, this could include a first read disturbance of the first LBA and a second read disturbance of the second LBA. The read disturbance detection module 216 copies the at least one LBA 304, i.e., LBAs 1, 3 and 4 to the GC buffer pool 212 in the memory 204. Then, the read command timeout monitoring module 220 monitors the command timeout of each of the at least one LBA 304, i.e., LBAs 1, 3 and 4 so that the LBA is copied to the GC buffer pool 212 before read command timeout for the respective LBA. By copying the at least one LBA 304, i.e., LBAs 1, 3 and 4 simultaneously, the read disturbance detection module 216 provides for each of the at least one LBA 304 being copied to the GC buffer pool 212 before the read command timeout and before the respective LBA goes into unreadable state. In one or more embodiments, first data associated with the first LBA is copied to the GC buffer pool and second data associated with the second LBA is copied to the GC buffer pool. Thereby protecting data associated with the at least one LBA 304, i.e., LBAs 1, 3 and 4.

The GC buffer pool 212 transmits the at least one LBA 304, i.e., LBAs 1, 3 and 4 to the reclaim GC buffer module 218. The reclaim GC buffer module 218 includes each LBA of the at least one LBA 304, i.e., LBAs 1, 3 and 4 in a reclaim GC queue 306 based on the order of occurrence of the read disturbance. For example, consider LBA 1 is copied to the GC buffer pool 212 first, followed by LBA 3 and then LBA 4. In this example, LBA 1 gets included in the reclaim GC queue 306 first, followed by LBA 3 and LBA 4. In other words, the first LBA and the second LBA may be ordered in the reclaim GC queue 306 based on an order of occurrence of the first read disturbance and the second read disturbance. In one or more embodiments, at least a part of the data to be written from the GC buffer pool 212 to a GC destination block 214, is based on a reclaim GC operation i.e., based on the order of occurrence of the read disturbance. The at least part of the data (first data and second data) is the data corresponding to a page in the respective LBA, with the read disturbance. For example, consider LBA 1 is being written to the GC destination block 214. In this example, pages 1 and 5 of LBA 1 is said to have read disturbance (as illustrated in FIG. 4). Therefore, the data corresponding to pages 1 and 5 of LBA 1 is written to the GC destination block 214.

The reclaim GC operation is an operation to restore only the data with the read disturbance. The at least part of the data is written to the GC destination block 214. Thereby, managing read disturbance in a storage device with intensive read workload, and avoiding at the at least part of the first data and the second data being lost.

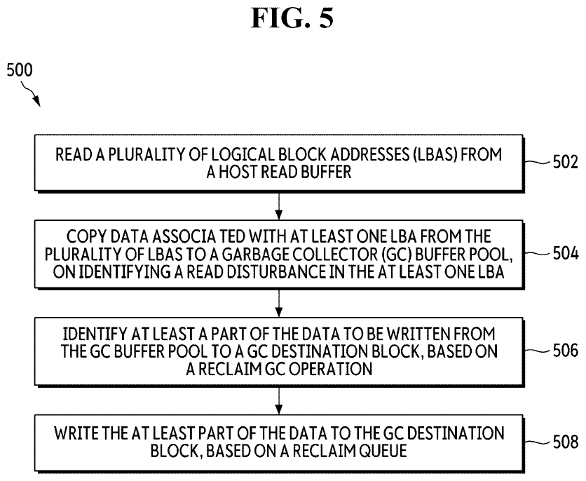

FIG. 5 illustrates a flow chart of a method 500 of managing read disturbance in the storage device 102 with intensive read workload, in accordance with one or more embodiments of the present disclosure.

At operation 502, the method 500 includes reading the plurality of LBAs 302 from a host read buffer 211. The processor 202 reads the plurality of LBAs 302 and identifies a read disturbance in at least one LBA 304 from the plurality of LBAs 302.

At operation 504, the method 500 includes copying data associated with at least one LBA 304 from the plurality of LBAs 302 to the Garbage Collector (GC) buffer pool 212 on identifying the read disturbance. The processor 202 copies the data associated with at least one LBA 304 before a read command timeout of the corresponding at least one LBA 304.

At operation 506, the method 500 includes identifying at least a part of the data to be written from the GC buffer pool 212 to a GC destination block 214, based on the reclaim GC operation. The processor 202 identifies at least part of the data based on an order of copying of the data associated with the at least one LBA 304. For example, consider LBAs 1, 3 and 4 are copied to the GC buffer pool 212. The GC buffer pool 212 comprises data associated with the LBAs 1, 3 and 4. Now, the processor 202 identifies at least part of the data for example, data associated with only LBA 1 as LBA 1 is copied first.

At operation 508, the method 500 includes writing the at least part of the data to the GC destination block 214, based on a reclaim GC queue 306. The reclaim GC queue 306 is based on an order of copying of the data associated with the at least one LBA 304. The processor 202 writes the at least part of the data to the GC destination block 214. In one or more embodiments, the processor 202 removes the at least part of the data associated with the at least one LBA 304 from the reclaim GC queue 306 and the GC buffer pool 212 upon completion of the writing.

The disclosed method 500 with reference to FIG. 5, may be implemented using software including computer-executable instructions stored on one or more computer-readable media (e.g., non-transitory computer-readable media, such as one or more optical media discs, volatile memory components (e.g., DRAM or SRAM), or non-volatile memory or storage components (e.g., hard drives or solid-state non-volatile memory components, such as Flash memory components) and executed on a computer (e.g., any suitable computer, such as a laptop computer, net book, Web book, tablet computing device, smart phone, or other mobile computing device). Such software may be executed, for example, on a single local computer.

The sequence of operations of the method 500 need not be necessarily executed in the same order as they are presented. Further, one or more operations may be grouped together and performed in the form of a single operation, or one operation may have several sub-operations that may be performed in parallel or in sequential manner.

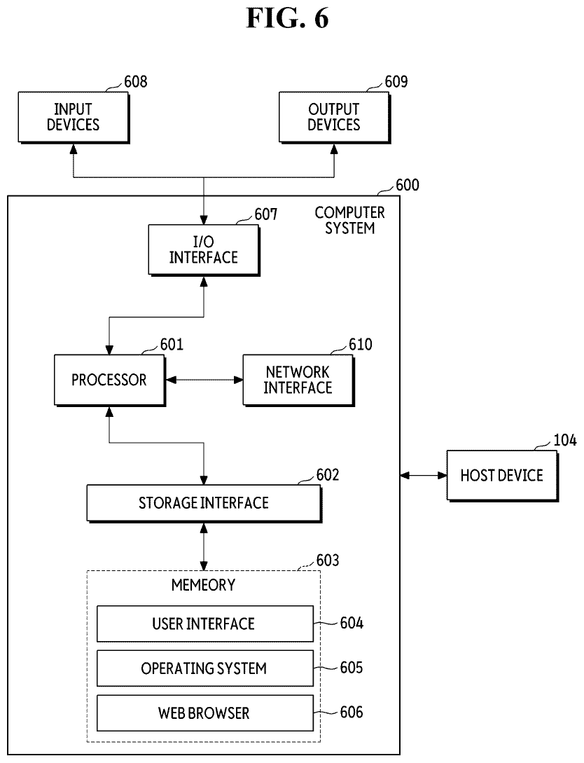

FIG. 6 illustrates a block diagram of an exemplary computer system 600 for implementing embodiments consistent with the present disclosure. In one or more embodiments, the computer system 600 may be used to implement the storage device 102. Thus, the computer system 600 may be used for managing read disturbance in the storage device 102 with intensive read workload. The computer system 600 may comprise a Central Processing Unit 604 (also referred as “CPU” or “processor”). The processor 604 may comprise at least one data processor. The processor 604 may include specialized processing units such as integrated system (bus) controllers, memory management control units, floating point units, graphics processing units, digital signal processing units, etc.

The processor 604 may be disposed in communication with one or more input/output (I/O) devices via I/O interface 602. The I/O interface 602 may employ communication protocols/methods such as, without limitation, audio, analog, digital, monoaural, RCA, stereo, IEEE (Institute of Electrical and Electronics Engineers)-1394, serial bus, universal serial bus (USB), infrared, PS/2, BNC, coaxial, component, composite, digital visual interface (DVI), high-definition multimedia interface (HDMI), Radio Frequency (RF) antennas, S-Video, VGA, IEEE 1016.n/b/g/n/x, Bluetooth, cellular (e.g., code-division multiple access (CDMA), high-speed packet access (HSPA+), global system for mobile communications (GSM), long-term evolution (LTE), WiMAX, or the like), etc.

Using the I/O interface 602, the computer system 600 may communicate with one or more I/O devices. For example, the input device 620 may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device 622 may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

The processor 604 may be disposed in communication with the communication network 618 via a network interface 606. The network interface 606 may employ connection protocols including, without limitation, direct connect, Ethernet (e.g., twisted pair 10/100/1000 Base T), transmission control protocol/internet protocol (TCP/IP), token ring, IEEE 1016.11a/b/g/n/x, etc. The communication network 618 may include, without limitation, a direct interconnection, local area network (LAN), wide area network (WAN), wireless network (e.g., using Wireless Application Protocol), the Internet, etc. The network interface 606 may employ connection protocols include, but not limited to, direct connect, Ethernet (e.g., twisted pair 10/100/1000 Base T), transmission control protocol/internet protocol (TCP/IP), token ring, IEEE 1016.11a/b/g/n/x, etc.

The communication network 618 includes, but is not limited to, a direct interconnection, an e-commerce network, a peer to peer (P2P) network, local area network (LAN), wide area network (WAN), wireless network (e.g., using Wireless Application Protocol), the Internet, Wi-Fi, and such. The first network and the second network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the first network and the second network may include a variety of network devices, including routers, bridges, servers, computing devices, storage devices, etc. The communication network 618 may be in communication with the host device 104 to manage read disturbance with intensive read workload.

In one or more embodiments, the processor 604 may be disposed in communication with a memory 610 (e.g., RAM, ROM, etc.) via a storage interface 608. The storage interface 608 may connect to memory 610 including, without limitation, memory drives, removable disc drives, etc., employing connection protocols such as serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 610 may store a collection of program or database components, including, without limitation, user interface 612, an operating system 614, web browser 616 etc. In one or more embodiments, computer system 600 may store user/application data, such as, the data, variables, records, etc., as described in this disclosure. Such databases may be implemented as fault-tolerant, relational, scalable, secure databases such as Oracle® or Sybase®.

The operating system 614 may facilitate resource management and operation of the computer system 600. Examples of operating systems include, without limitation, APPLE MACINTOSH® OS X, UNIX®, UNIX-like system distributions (E.G., BERKELEY SOFTWARE DISTRIBUTION™ (BSD), FREEBSD™, NETBSD™, OPENBSD™, etc.), LINUX DISTRIBUTIONS™ (E.G., RED HAT™, UBUNTU™, KUBUNTU™, etc.), IBM™ OS/2, MICROSOFT™ WINDOWS™ (XP™, VISTA™/7/8, 10 etc.), APPLE® IOS™, GOOGLE® ANDROID™, BLACKBERRY® OS, or the like.

In one or more embodiments, the computer system 600 may implement the web browser 616 stored program component. The web browser 616 may be a hypertext viewing application, for example MICROSOFT® INTERNET EXPLORER™, GOOGLE® CHROME™⁰, MOZILLA® FIREFOX™, APPLE® SAFARI™, etc. Secure web browsing may be provided using Secure Hypertext Transport Protocol (HTTPS), Secure Sockets Layer (SSL), Transport Layer Security (TLS), etc. Web browsers 616 may utilize facilities such as AJAX™, DHTML™, ADOBE® FLASH™, JAVASCRIPT™, JAVA™, Application Programming Interfaces (APIs), etc. In one or more embodiments, the computer system 600 may implement a mail server stored program component. The mail server may be an Internet mail server such as Microsoft Exchange, or the like. The mail server may utilize facilities such as ASP™, ACTIVEX™, ANSI™ C++/C #, MICROSOFT®, .NET™, CGI SCRIPTS™, JAVA™, JAVASCRIPT™, PERL™, PHP™, PYTHON™, WEBOBJECTS™, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In one or more embodiments, the computer system 600 may implement a mail client stored program component. The mail client may be a mail viewing application, such as APPLE® MAIL™, MICROSOFT® ENTOURAGE™, MICROSOFT® OUTLOOK™, MOZILLA® THUNDERBIRD™, Etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform operations or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, non-volatile memory, hard drives, Compact Disc Read-Only Memory (CD ROMs), Digital Video Disc (DVDs), flash drives, disks, and any other known physical storage media.

The present disclosure provides methods and systems managing read disturbance in a storage device with intensive read workload. In the present disclosure, the storage device identifies all the LBAs with read disturbance and copies them to a GC buffer pool. Thereby, ensuring that no data is lost when the read disturbance occurs. Further, the storage device copies data associated with each of the LBAs simultaneously, thereby providing that the data is copied before read command timeout thereby, protecting the data before it goes into unreadable state. Moreover, in related art systems, the LBAs were copied sequentially making them time-consuming, however, the storage device of the present disclosure copies the LBAs simultaneously ensuring the management of read disturbance is faster. Thereby, also improving the storage device efficiency.

Embodiments of the method and device described herein improve the functioning of a computer by improving memory performance and avoiding data loss. These problems of memory performance and data loss are confined to the realm of computation and networks. Thus, embodiments herein are necessarily rooted in computer technology in order to overcome a problem specifically arising in the realm of computer networks. It is to be understood, however, that the advantages of the present invention are not limited to the foregoing description.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise. The terms “a”, “an” and “the” mean “one or more”, unless expressly specified otherwise.

A description of one or more embodiments with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIG. 5 show certain events occurring in a certain order. In alternative embodiments, certain operations may be performed in a different order, modified, or removed. Moreover, operations may be added to the above-described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

What is claimed is:

1. A method of managing read disturbance in a storage device, the method comprising:
reading a first Logical Block Addresses (LBA) from a host read buffer;
identifying a first read disturbance in the first LBA;
copying first data associated with the first LBA to a Garbage Collector (GC) buffer pool, based on the identifying the first read disturbance;
reading a second LBA from the host read buffer;
identifying a second read disturbance in the second LBA;
copying second data associated with the second LBA to the GC buffer pool, based on the identifying the second read disturbance;
generating a reclaim queue comprising the first LBA and the second LBA;
identifying at least part of the first data and the second data to be written from the GC buffer pool to a GC destination block; and
writing the at least part of the first data and the second data to the GC destination block, based on the reclaim queue, to avoid the at least part of the first data and the second data being lost.

2. The method as claimed in claim 1, wherein the first LBA and the second LBA are ordered in the reclaim queue based on an order of occurrence of the first read disturbance and the second read disturbance.

3. The method as claimed in claim 1, further comprising:
removing the at least part of the first data and the second data from the reclaim queue and the GC buffer pool based on completion of the writing.

4. The method as claimed in claim 1, wherein copying the first data is performed before a read command timeout of the first LBA.

5. A storage device for managing read disturbance in the storage device, the storage device comprising:
at least one processor; and
memory configured to store instructions that, when executed by the at least one processor, cause the at least one processor to:
read a first Logical Block Addresses (LBA) from a host read buffer;
identify a first read disturbance in the first LBA;
copy first data associated with the first LBA to a Garbage Collector (GC) buffer pool, based on identifying the first read disturbance;
read a second LBA from the host read buffer;
identify a second read disturbance in the second LBA;
copy second data associated with the second LBA to the GC buffer pool, based on the identifying the second read disturbance;
generate a reclaim queue comprising the first LBA and the second LBA;
identify at least part of the first data and the second data to be written from the GC buffer pool to a GC destination block; and
write the at least part of the first data and the second data to the GC destination block, based on the reclaim queue, to avoid the at least part of the first data and the second data being lost.

6. The storage device as claimed in claim 5, wherein the first LBA and the second LBA are ordered in the reclaim queue based on an order of occurrence of the first read disturbance and the second read disturbance.

7. The storage device as claimed in claim 5, wherein the instructions further cause the at least one processor to:
remove the at least part of the first data and the second data from the reclaim queue and the GC buffer pool based on completion of the writing.

8. The storage device as claimed in claim 5, wherein the instructions further cause the at least one processor to copy the first data before a read command timeout of the first LBA.

9. A non-transitory computer-readable storage medium, having a program stored thereon that performs, when executed by at least one processor:
reading a first Logical Block Addresses (LBA) from a host read buffer;
identifying a first read disturbance in the first LBA;
copying first data associated with the first LBA to a Garbage Collector (GC) buffer pool, based on the identifying the first read disturbance;
reading a second LBA from the host read buffer;
identifying a second read disturbance in the second LBA;
copying second data associated with the second LBA to the GC buffer pool, based on the identifying the second read disturbance;
generating a reclaim queue comprising the first LBA and the second LBA;
identifying at least part of the first data and the second data to be written from the GC buffer pool to a GC destination block; and
writing the at least part of the first data and the second data to the GC destination block, based on the reclaim queue, to avoid the at least part of the first data and the second data being lost.

10. The non-transitory-computer readable storage medium claimed in claim 9, wherein the first LBA and the second LBA are ordered in the reclaim queue based on an order of occurrence of the first read disturbance and the second read disturbance.

11. The non-transitory computer-readable storage medium claimed in claim 9, wherein the program further performs:
removing the at least part of the first data and the second data from the reclaim queue and the GC buffer pool based on completion of the writing.

12. The non-transitory computer-readable storage medium claimed in claim 9, wherein the program further performs:
copying the first data before a read command timeout of the first LBA.
